(19) United States
(12) Patent Application Publication
(10) Pub. No.: US 2006/0288226 A1
(43) Pub. Date: Dec. 21, 2006

(54) System and method for establishing and authorizing a security code

(75) Inventor: Marek R. Kowal, Rockville, MD (US)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: Stelor Productions, LLC.

(21) Appl. No.: 11/152,259

(22) Filed: Jun. 15, 2005

(51) Int. Cl. H04L 9/00

(52) U.S. Cl. 713/182

(57) ABSTRACT

A system and method for controlling access to a resource is provided. A user provides input to the system. Based on the user inputs, a security code may be automatically assembled by extracting stored data. If the assembled security code matches a required value, access may be granted. Otherwise, the user may be denied access to the resource.

### TECHNICAL FIELD

The invention relates generally to authorization of access to information and, more particularly, a system and method for establishing and using a secure security code.

### BACKGROUND

This invention relates generally to a system and method designed to allow access to a resource. Security codes such as passwords are commonly used throughout a number of fields to allow authorized users to access locations and information, and deny access to unauthorized users. Passwords have a variety of applications such as personal computing, wide and local area network access, television monitoring systems, cell phones, gate systems, and in a variety of commercial settings.

As the value of the resource being protected increases, the complexity of the password likewise may increase. For example, information used in certain applications, such as in the banking industry or other commercial settings, require complex passwords to increase security. Unauthorized users often attempt to steal a password by monitoring the keystrokes on a personal computer, creating software to automatically guess passwords, or through other malicious methods. Longer, more complex passwords using a combination of letters, symbols, and numbers increase the security of the system. As the complexity increases, guessing the proper password is more difficult due to the greater number of combinations.

However, complex passwords may be difficult to remember. Authorized users may forget their password and be denied access to their own information. Also, users may write down the password either on paper or in electronic form, allowing a malicious user access to the system upon discovering the paper or file. Because users may be unlikely to remember multiple complex passwords, often users will use the same complex password for a plurality of systems. Once a malicious user guesses the appropriate password to one system, unauthorized access may be obtained for all of the user's systems.

Users would likely prefer to have the increased security obtained through complex security codes without having to remember a complex password. Systems and methods consistent with this invention allow a user to easily identify a data store that automatically generates a complex security code for the user.

### SUMMARY

Consistent with the invention, methods, apparatus, and computer readable media for controlling access to a resource are provided.

Consistent with the invention, a method for establishing a security code may comprise creating at least one data item, receiving a user selection of the at least one of the data item, associating the data item with at least one container file containing a plurality of data values, specifying locations of a plurality of data values in the container file to form the security code, and establishing the security code from the plurality of data values in the specified locations.

Consistent with the invention, a method for controlling access to a resource may comprise associating at least one container file comprising at least one data value with at least one data item, presenting at least one of the data items to a user, receiving a user selection of at least one of the data items, accessing at least one container file associated with the at least one selected data item, assembling the at least one data value from the at least one accessed container file into a security code, and using the security code to control access to the resource.

It is to be understood that both the foregoing general description and the following detailed description are exemplary and explanatory only and are not restrictive of the invention, as claimed. The accompanying drawings, which are incorporated in and constitute a part of this specification, illustrate embodiments consistent with the invention and together with the description, serve to explain the principles of the invention.

### BRIEF DESCRIPTION OF THE DRAWINGS

FIG. 1 is a system for controlling access to a resource.

FIG. 2 is a flow chart of a method for establishing a security code.

FIG. 3 is a flow chart of a method for associating data items with container files.

FIG. 4 is a flow chart of a method for specifying locations of data values in the container files.

FIG. 5 is a flow chart of a method for forming an established security code from data values.

FIG. 6 is a flow chart of a method for using an established security code to determine whether a user should be granted access to a resource.

FIG. 7 is an exemplary data store in the form of an image.

FIG. 8 is an exemplary system for use with a data store in the form of an image file to both create a security code and selectively grant access to a resource.

FIG. 9 is a flow chart of an exemplary method for establishing a security code using an image.

FIG. 10 is an exemplary container file showing color values for pixels.

FIG. 11 is an exemplary pixel color value change used for establishing a security code.

FIG. 12 is a flow chart of an exemplary method for authorizing access to a resource using a data store in the form of an image.

FIG. 13 is a flow chart of an exemplary method for assembling a security code and determining if the assembled security code matches an established security code.

### DETAILED DESCRIPTION

Reference will now be made in detail to the exemplary embodiments of the invention, examples of which are illustrated in the accompanying drawings. Wherever possible, the same reference numbers will be used throughout the drawings to refer to the same or like parts.

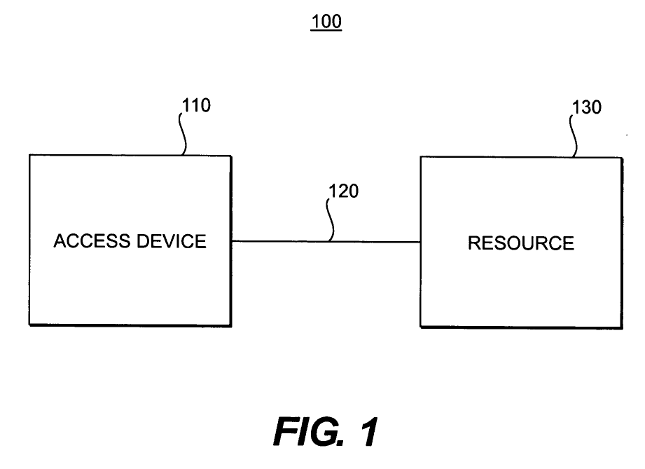

FIG. 1 shows a system consistent with the invention for providing controlled access to a resource. Access device 110 allows a user to obtain access to a resource 130 which is restricted to authorized users. Access device 110 and resource 130 may be connected using connection 120. Access device 110 may be, for example, a personal computer, a touch screen panel, or a security keypad. Resource 130 may be, for example, information stored within the same system as access device 110, or remotely accessed via connection 120. Connection 120 may provide a connection over any local or wide area network, such as the Internet. Alternatively, resource 130 may be some other type of resource, such as physical location protected by a security perimeter, and access device 110 may be a door lock.

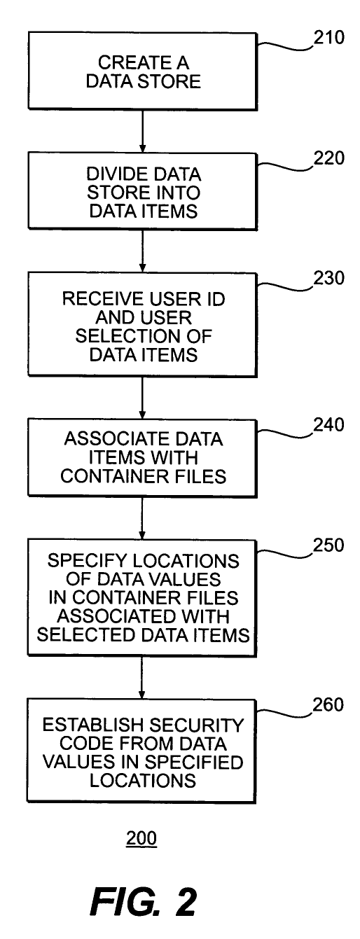

FIG. 2 shows an exemplary flow chart of a method 200 for creating, or establishing, a security code. This established security code may be used, or stored, to selectively grant or prohibit access to a user by comparing the established security code with some type of input which is received from a user desiring access to the resource.

The first step 210 may be to create one or more data stores. The user may choose the data store to be used in creating the security code. Alternatively, the data stores may be chosen by the system. The data stores may be any type of stored information arranged in a recognizable manner, such as images, pictures, audio files, binary data files, biometric data, data libraries, or web pages.

Next, at step 220 the data stores may be divided into one or more portions, referred to as data items. These data items may be easily recognized by the user and may be used to form part or all of a security code.

At step 230, a user identification is received using any appropriate method. For example, a user name may be received, such as from keyboard entries, selection of image files, or selection of audio files. User identification may also be received using a biometrics sensor, such as a fingerprint reader.

Data stores may be presented to the user. If more than one data store is presented, a user may first select a preferred data store for use in establishing their security code. The data store presentation may be, for example, in the form of a display of images containing a plurality of sub-images as the data items. The user may then be allowed to select one or more of the data items from within the selected data store. Identification of the selected data items may then be received from the user. A user may be required to repeat the selections, in either the same selection sequence or any selection sequence, to ensure accurate setup.

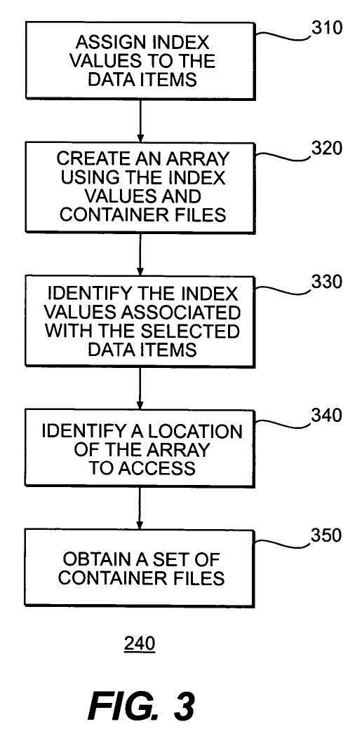

At step 240 the data items may be associated with data values. The association may be accomplished in the form of at least one link to a container file containing data values. The link may be a value to identify a location of the container file, such as an address, or a call to a function that may locate the container file, described in more detail with reference to FIG. 3. Step 240 may also be performed prior to step 230.

The container files may be stored in one or more directories, and may be local or remote to access device 110. The directory containing container files may store container files for one or more of the data items, as well as container files unrelated to the data items. The container files may be any set of data. For example, the container files may be image data corresponding to the sub-images, data selected randomly from a database, data created by an algorithm processing the data items, or data selected using a search engine.

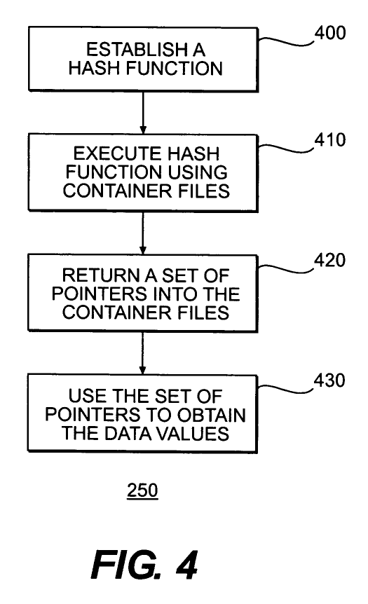

At step 250 the locations of the data values in the container files associated with the selected data items may be specified. The data values may be used to establish the security code. For example, the locations of the data values may be determined based on a hash function, described in more detail with reference to FIG. 4.

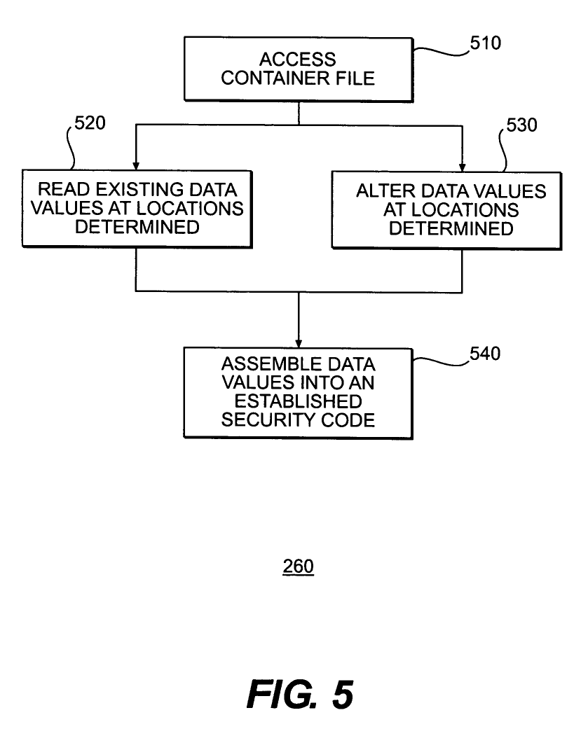

At step 260, the data values stored in the specified locations are used to establish the security code, described in more detail with reference to FIG. 5. This established security code may then be used in selectively granting access to resource 130. For example, the established security code may be used to encrypt known data in a file. The file may be, for example, an image file, picture file, audio file, binary data file, biometrics data file, data libraries, or web pages in the form of, for example, html files. The encryption may be accomplishing using any method appreciated by those of ordinary skill in the art, such as an XOR method (simplified version) or RSA method (more advanced).

FIG. 3 shows exemplary details of step 240 (FIG. 2) for associating data items with container files. At step 310, index values may be assigned to the data items. At step 320, the index values for the data items may be used to create an array. The array may comprise a plurality of locations containing information pointing to container files containing data values. For example, the array may have a dimensions equivalent to the number of data items utilized to form the established security code. In particular, the data store may contain ten data items and the system may require the user to select three data items to establish a security code. Each of the ten data items may have an index from one to ten associated with it. A three-dimensional array may then be formed, each dimension containing ten locations. The array locations may in turn link to a set of container files. For example, each array location may contain the names of three container files.

At step 330, the index values associated with selected data items may be identified, for example, in the same sequence as the user selections. Using the above example, suppose the user selected three data items, such as the first, the fourth, and the sixth data items. Index values of 1, 4, and 6 may be identified. At step 340, the identified index values may then be used to identify a location of the array to access, such as the array location specified by array coordinates 1, 4, 6. At step 350, the set of container files may be then be identified using the information stored in the identified location (e.g., location 1, 4, 6) of the array.

FIG. 4 shows exemplary details of step 250 (FIG. 2) for specifying the locations of data values in the container files. At step 400 creation, or re-parameterization, of an algorithm, such as a hash function, may be performed. At step 410, the hash function may be executed using the names of the container files identified in step 240 (FIG. 2). At step 420, the hash function may return a set of pointers into the named container files. The pointers may be, for example, offset values into one or more container files. The set of pointers may be the same or may be unique for each container file.

At step 430, the pointers may be used, or stored, for accessing information in the specified locations of the container files. The accessed information may be, for example, data values for use in establishing the security code. Alternatively, the accessed information may be data values for use in executing a further mathematical function. The result of the further mathematical function may then identify the data values to be used in establishing the security code.

FIG. 5 shows exemplary details of step 260 (FIG. 2) for forming an established security code from data values. At step 510 the identified container file(s) may be accessed using the pointers provided by the hash function. At step 520, the security code may be established, consisting of the data values stored in the locations determined in step 250 (FIG. 2), such as the values stored in the pointed to locations of the identified container file(s).

Alternatively, at step 530, the security code may be established by first altering data values at the container file locations determined in step 250 (FIG. 2). The data values may be altered using any appropriate method as appreciated by those skilled in the art, such as change by a pre-defined amount, change through use of a formula, change according to a random number generator, or change by detecting noise, such as on a network or cable. Exemplary applications that may use the alternative method of step 530 will be described below.

At step 540, the data values at the determined locations may be assembled from the container files to form the established security code. Assembling the data values may comprise, for example, appending the data values together.

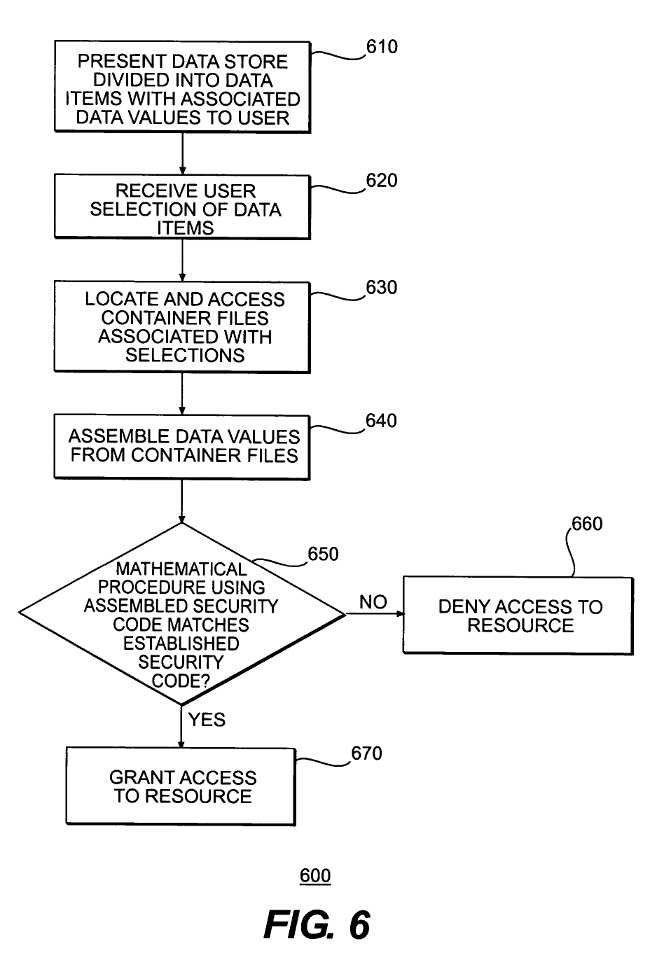

FIG. 6 shows an exemplary flow chart of a method 600 for using the established security code to determine whether a user should be granted access to a resource. The first step may be to identify a user. At step 610 the data store selected in step 230 (FIG. 2) may be presented to the identified user. At step 620 a user selection of at least one of the data items may be received.

At step 630 the container files associated with the selected data items may be located and accessed. The container files may be located by accessing a link in the data item to the container files. Alternatively, the container files may be located by using index values into an array, as discussed above. A single container file may also be accessed to assemble the security code.

At step 640 the data values in the container files associated with the selected data items may be assembled. Assembling the data values may be accomplished by locating the locations of the data values within the container files using the same version of a hash function used to establish the security code. For example, the offsets into the container files may be returned from the hash function. The data values at the offsets may be accessed and assembled from the container files to form an assembled security code.

Next, at step 650 the assembled security code may be compared to the established security code using a mathematical function to see if a match exists. The mathematical function may be predefined. The assembled security code must form a correct sequence. Alternatively, instead of storing the establish security code for comparison, the established security code may be used as a key to encrypt a file. The assembled security code may then be used as a key to decrypt the encrypted file. In this manner, the established security code itself need not be stored in the system, where the established security code may be vulnerable to hackers.

At step 660 access to the resource may be denied if the decryption process fails. At step 670 access to the resource may be granted if the assembled security code successfully decrypts the encrypted file. For example, a data screen may be presented to a user or a gate lock may be opened. Methods described above may be performed by a processor, such as a computer, executing instructions stored on a computer-readable medium.

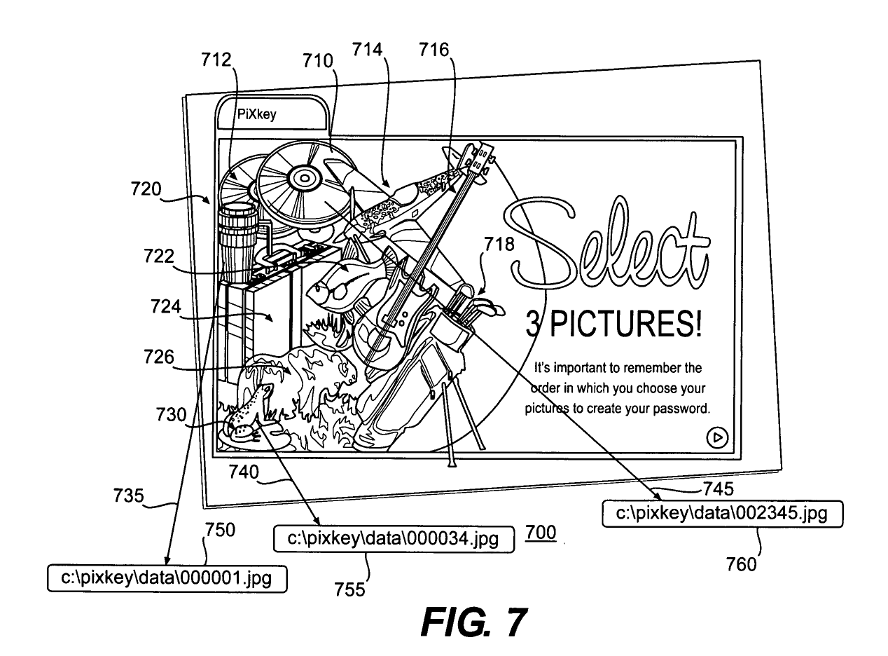

FIG. 7 shows an exemplary data store in the form of data representing an image 700. Data forming image 700 may be stored in any appropriate type of a data file, such as jpeg format, as appreciated by those skilled in the art. Image 700 may be chosen by the user or be provided by the system. Image 700 may be divided into sub-images 710, 712, 714, 716, 718, 720, 722, 724, 726, and 730. Consistent with the invention, establishing the security code may require selection of one or more sub-images using either a specified selection sequence or non-specified selection sequence, depending on the level of security required.

In order to establish a security code, as described above, the user may select sub-images using any appropriate method, such as “point and click,” a touch panel, or voice activation. For example, the user may click on sub-images 710 (CD), 720 (travel mug), and 730 (frog). As the user makes selections, the sub-images may be distinguished, using any appropriate method, such as highlighting, to confirm the selection to the user. Alternatively, the sub-images serving as the established security code may be specified by the system and provided to the user, such as by sequentially highlighting sub-images 710, 720, and 730.

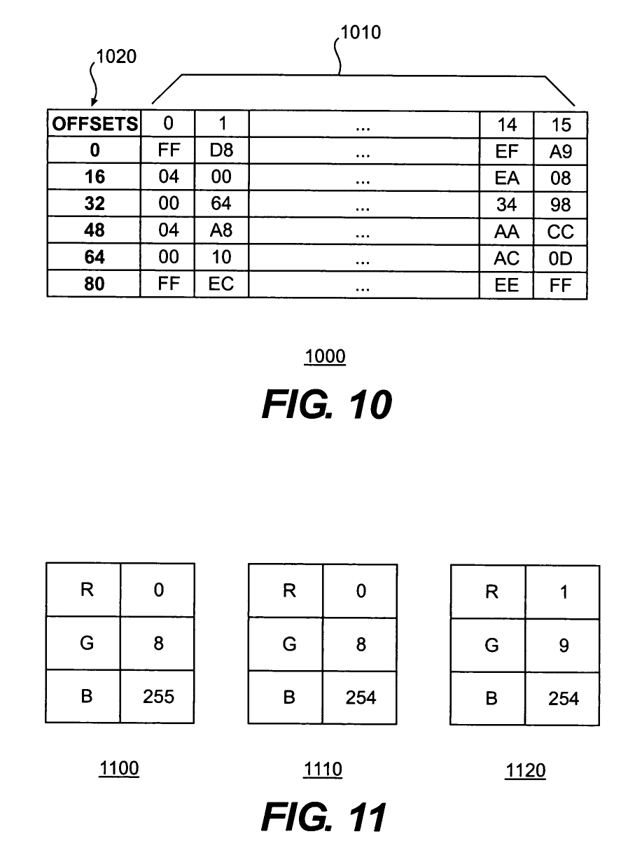

As shown schematically in FIG. 7, sub-images 710, 720, and 730 may comprise one or more links 735, 740, and 745 to container files 750, 755, and 760. Exemplary container files will be described in more detail with reference to FIG. 10.

The links may identify the container files. The identification may be made using, for example, a file name, an address, or a call to a function. For example, the function may use array index values to specify the container files as described above. The container files may be stored in one or more directories, and may be local or remote to access device 110. The directory containing container files may store container files of one or more of the selected sub-images, as well as container files not selected, and/or container files unrelated to the image.

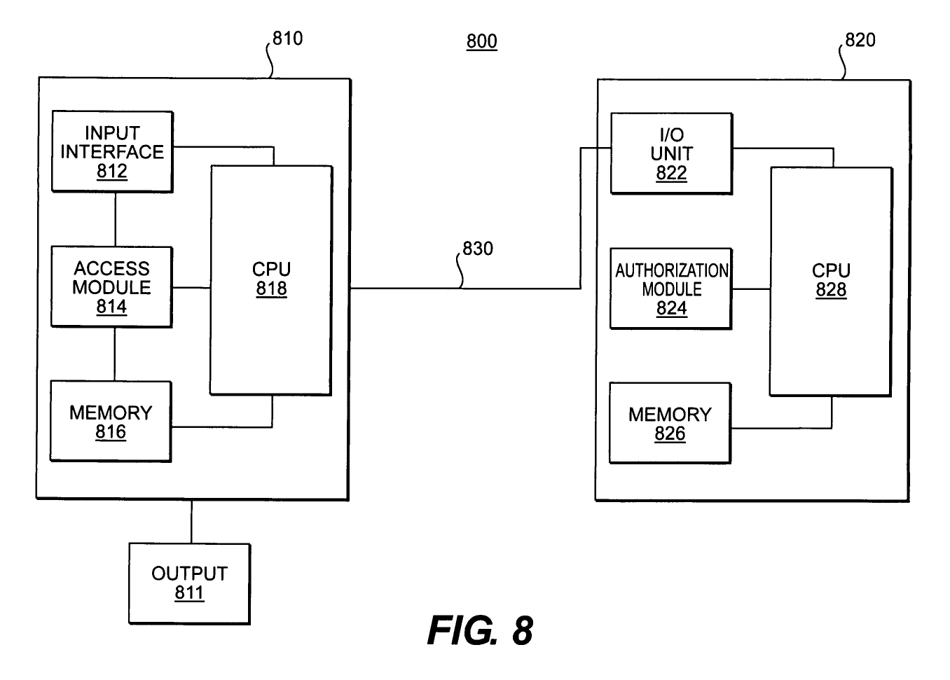

FIG. 8 shows an exemplary system 800 for use with a data store in the form of an image file to both create a security code and selectively grant access to a resource, conditioned on entry of the established security code. System 800 may comprise, for example, a user access device 810. User access device 810 may contain an output 811 for presenting information to a user, and an input interface 812 for receiving user selections, for example, through a touch screen, voice activation, mouse click, or keyboard. Input interface 812 may provide user selections to an access module 814, which may control execution of software by a CPU 818. Software may be used to create the established security code and to assemble a security code through selection of sub-images. Memory 816 may be any appropriate memory as appreciated by those skilled in the art, and may contain all or part of image 700, sub-images 710, 712, . . . 730 and associated container files, and the established security code.

User access device 810 may be connected via connection 830 to an authorization device 820. Connection 830 may be, for example, the Internet and authorization device 820 may be, for example, a server. Authorization device 820 communicates with user access device 810 via input/output (I/O) unit 822. Input/output unit 822 may be an appropriate communications device, for example, an Ethernet device, modem device, infra-red device, RF device, or other wireless device as appreciated by those skilled in the art.

In system 800, the resource 130 (FIG. 1), for which access is selectively granted, may be data files stored in memory 816. Resource 130 may be stored on a separate device connected by, for example, the Internet.

Authorization module 824 may control execution of software by a CPU 828 to store an established security code received from user access device 810 and, later, to determine if an assembled security code received from user access device 810 matches the established security code stored in memory 826. If the security code does match, an authorization signal, such as a secure session key, may be provided from authorization device 820 to user access device 810, thereby allowing access to data files stored in memory 816. Memory 826 may also store all or part of image 700, sub-images 710, 712, . . . 730 and associated container files, the established security code, and resource 130.

The system shown in FIG. 8 may be any appropriate system capable of executing a sequence of operations, such as software programming or computer program code instructions. The stored data, such as data stores, data items, container files, and data values may be digital or analog, and may be stored at the time of manufacturing, such as in a programmable logic device.

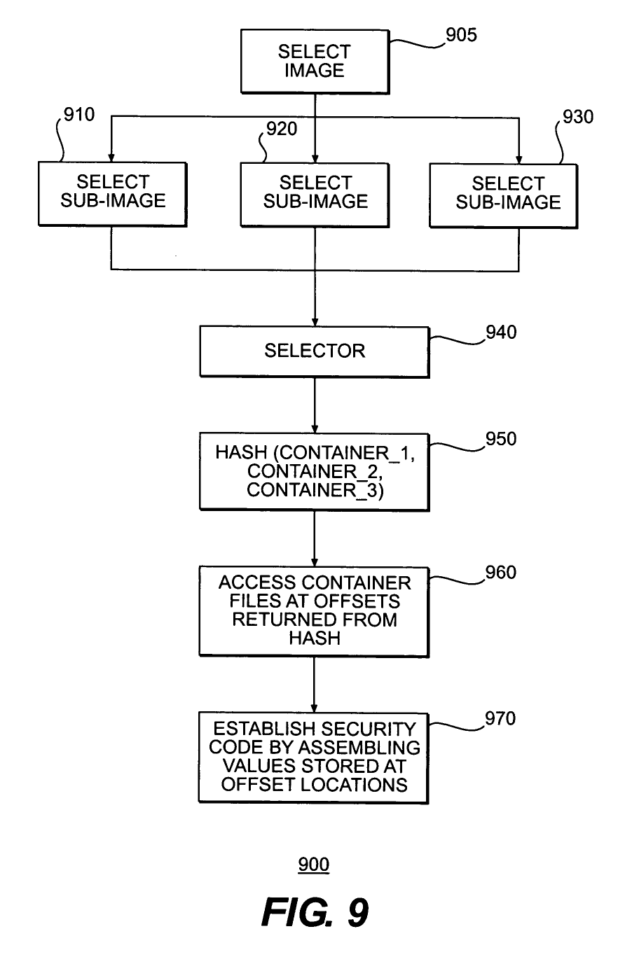

As an example of establishing a security code as described above (FIG. 2), FIG. 9 shows a method 900 for establishing a security code using images. At step 905, an identified user may first select a data store in the form of an image. Next, at steps 910, 920, and 930 the user may select data items in the form of sub-images. The selected sub-images may link as index values into a selector in the form of an array. At step 940, the selector may use the index values associated with the selected sub-images to access the array and return one or more associations to data. These associations to data may be, for example, an address or filename for one or more container files.

At step 950, an algorithm, such as a hash function, may be executed using the filenames for the one or more container files to return a set of pointers, or offset locations. At step 960, the container files may be accessed at the offset locations.

Next, at step 970 the security code may be established by assembling the data values stored in the offset locations. The established security code may be stored directly or by altering the values at the locations offset in the container files. For example, if the container file is an image file, the pixel color values may be altered when a user establishes his or her security code at locations determined from a hash function. Altering pixel color values may be accomplished, for example, as described with reference to FIG. 10. Alternatively, the color values may not be altered and the security code may be established by reading unaltered data values at the offsets returned from the hash function.

FIG. 10 shows an exemplary container file 1000. Container file 1000 may comprise color values 1010, which may be in hexadecimal format, such that every two characters represent eight bits. As will be appreciated by those of ordinary skill in the art, offsets 1020 into the file are shown in the left side starting at 0. Container file 1000 may be in any appropriate data file format, such as a raster graphics image format, digital image format, GIF format, TIFF format, or bitmap format, as appreciated by those skilled in the art. Alternatively, container file 1000 may be a randomly generated set of data. There may be, for example, a one to one correspondence between sub-image 710 and container file 1000. Also, there may be a one to many correspondence between sub-image 710 and a plurality of container files.

If container file 1000 contains pixel values, a color model may be used to define the colors for pixels of the sub-image. The color model may be, for example, RGB (Red, Green, Blue), CMYK (Cyan, Magenta, Yellow, and Black), YIQ, YCbCr, or another model, such as black and white, as appreciated by those skilled in the art. The RGB color model may be used to define pixel color values. The pixel color values may serve as data values and be located using offsets into container file 1000.

Altering data values associated with the sub-images may comprise altered pixel color values for pixels within the container file 1000. These pixel color values may be altered using any appropriate method as appreciated by those skilled in the art, such as change by a pre-defined amount, change through use of a formula, change according to a random number generator, or change by detecting noise, such as on a network or cable. The pixel color values may also be changed such that the change is either noticeable or is not noticeable by the user.

As seen in FIG. 11, pixel value 1100 is shown with an exemplary RGB pixel color value of (0, 8, 255). The blue color value may be slightly altered to 254 as shown in 1110. Alternatively, more than one color value may be altered for pixels as shown in 1120. Pixel color values may be altered not only for those sub-images chosen by the user, but also for sub-images not chosen in order to increase security.

The pixel color values may be altered using, for example, the least significant bit at the determined offset. To vary both security and number of colors available, pixel color values may be presented by varying numbers of bits. For example, the R, G, and B pixel color values may be represented using eight bits each, to create 24-bit color depth for each pixel. In this case, RGB pixel color values (0, 8, 255) for pixel value 1100 may be represented in eight bits as (00000000, 00001000, 11111111). Pixel value 1100 may represent a pixel in the sub-image before alteration. Items 1110 and 1120 may represent pixel value 1100 after alteration to form an established security code. As seen at 1110, the altered data value of (0, 8, 254) may be represented in eight bits as (00000000, 00001000, 11111110). As seen at 1120, the altered data value of (1,9,254) may be represented in eight bits as (00000001, 00001001, 11111110). The data values may be stored in a container file as seen in FIG. 10.

These altered data values may be combined in any appropriate manner into data values representing, for example, ASCII characters, to form an established security code, as appreciated by those skilled in the art. The established security may be stored using character values for later comparison as described above.

For example, by sampling the two least significant bits for RGB in pixel value 1100, a six-bit representation of 000011 may be formed. 000011 may then be padded in the two most significant bits with 01. 01000011 in ASCII represents the character C. In the case of pixel value 1120, for example, the two least significant bits may be combined in the order of RGB, forming 010110. 010110 may then be padded in the two most significant bits with 01. 01010110 in ASCII represents the character V. Therefore, in this example, the character C has been modified using altered pixel color values to the character V. However, the pixel corresponding to altered pixel value 1100, pixel value 1120, will be visually indistinguishable from the pixel displayed for the original pixel value 1100. Thus, the displayed image appears the same to the user.

The order and method of choosing bits for use to assemble an ASCII character may vary according to the appropriate security code. For example, a single least significant bit may be used from a plurality of pixels, multiple least significant bits may be used from a given color, pixel color values may be sampled for one or more colors, or any combination thereof. The bits may be subject to a mathematical operation during assembly, for example, the bits may be shifted, multiplied, divided, added, or subtracted. Eight least significant bits may be combined without padding to form an ASCII character.

Once the user makes a selection of sub-images 710, 720, and 730, to establish a security code as discussed at step 230 (FIG. 2), the pixel color values of image 700 may be stored as a unique image for the user, for example, by associating the image with a user name. Separate images 700 associated with different users may appear identical. However, the stored container files containing data representing the separate images may actually be unique due to altered pixel color values. Therefore, a unique security code may be established for each user during setup for use in the established security code, even if each user uses the apparently identical displayed images and even if the different users choose sub-images appearing to be the same.

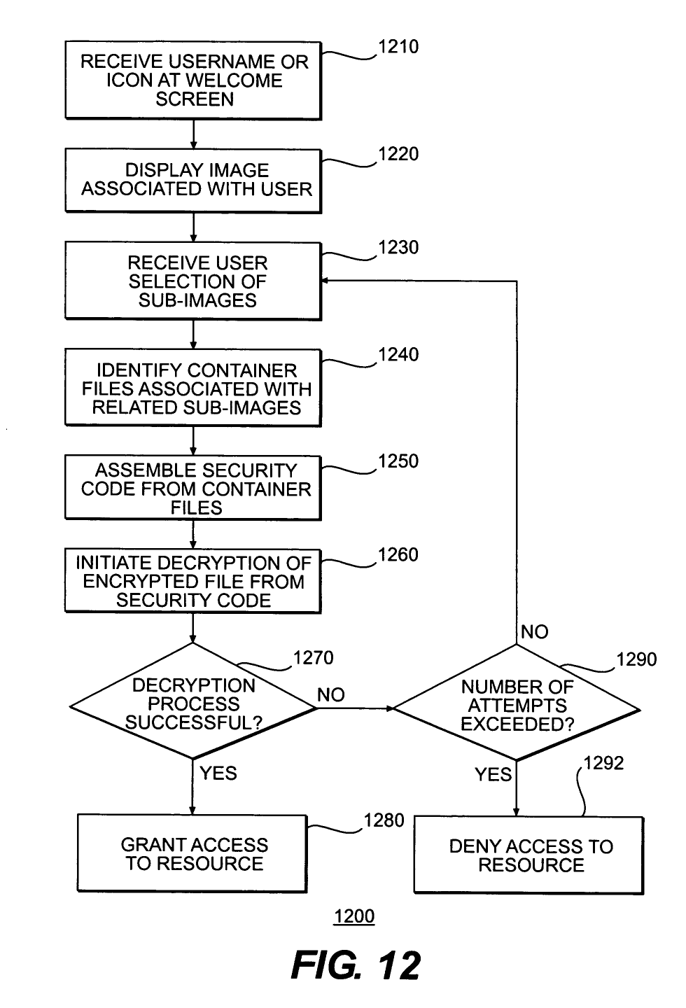

FIG. 12 shows an exemplary flow chart of a method 1200 for allowing a user to gain access to a resource. At step 1210, a user identification, such as a username or icon, is received. Users may also be identified by other appropriate methods, as appreciated by those skilled in the art. Examples include use of biometrics or a data card with embedded information, such as a smart card. Alternatively, the system may be designed for only one user, such that a username may not be necessary.

Each user of a system may have stored a different version of an image. At step 1220, based on the received username, a specific version of image 700 is selected and displayed to the user. The image may also be continuously displayed, such as on a security panel. At step 1230, the user selects sub-images 710, 720, and 730 using a method such as a touch screen, mouse click, keyboard, or by voice activation. The image 700 may be relocated on the display after a given number of access attempts, randomly, or every time a user attempts to access the resource. In this manner, malicious monitoring of keystrokes or the location of selections to determine the sub-images selected may be defeated.

For increased security, sub-images 710, 720, and 730 may be required to be selected in the same sequence as selected by the user during creation of the established security code. If the user does not select the sub-images 710, 720, and 730 in the correct sequence, the user may be denied access to the resource. Alternatively, if the user does not select the sub-images in the correct sequence, an assembled security code may be formed as described below. However, the assembled security code will not match the established security code and the user will be denied access to the resource.

At step 1240, if the user selects sub-images 710, 720, and 730 in the correct sequence, links to the at least one container file 1000 may be executed for sub-images 710, 720, and 730. Alternatively, a selector may be used to retrieve index values to the sub-images. For example, a selector may use index values associated with selected data items to access a location in an array. The array may have an equivalent number of dimensions as the number of data items utilized to form the established security code. For example, if the user selected three data items to serve in their security code from an available ten data items, a three dimensional array may be used with ten index values. The array locations in turn link to a set of container files. When a user selects a sequence of sub-images, the associated index values may be stored to access the array and return a set of container files to use for assembling the security code.

Next, at step 1250 the security code may be assembled from the container files associated with the sub-images. Details of step 1250 will be described below.

At step 1260 if the established security code has been used to encrypt a file, completed assembly of a security code may initiate decryption of the encrypted file. A comparison is then performed to determine if the assembled security code properly decrypts the file. If the decryption succeeds at step 1270, the assembled security code matches the established security code. At step 1280, the user may then be granted access to the resource.

However, if the decryption fails at step 1290, the assembled security code does not match the established security code. The system may determine if the maximum number of attempts has been exceeded. A maximum number of attempts may be established to defeat malicious users from repeatedly attempting to guess the established security code. If the number of attempts has not been exceeded, the user may be allowed to once again select sub-images. At step 992 access may be denied if the number of attempts has been exceeded, and the user may be required to establish a new security code.

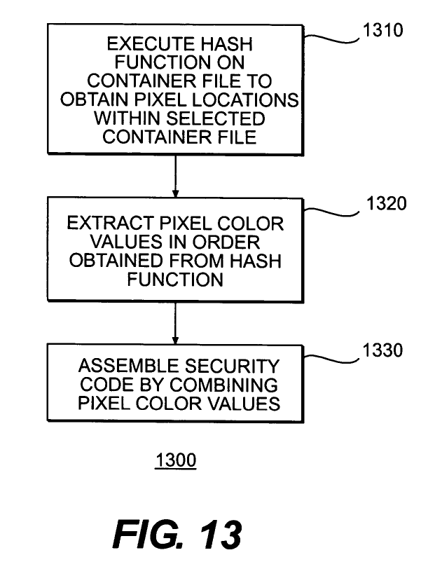

FIG. 13 shows an exemplary method 1300 of forming the assembled security code in step 1250. At least one container file may be stored for a user. The first step 1310 may be to execute a hash function on the container file to obtain offsets. The offsets may be used to identify locations in the container file. The locations may be identified by returning offsets for bits. Any number of pixel locations may be required to increase security. The hash function may be executed using any method appreciated by those skilled in the art, such as a CRC hash. The hash function may use the container file name or other data such as the user name as an argument to produce a unique sequence for each container file.

Next, at step 1320 the pixel color values for identified pixels in the container file may be extracted in order at the offsets identified from the hash function. At step 1330 these extracted pixel color values may be combined into an assembled security code. The hash function, storage of container files, and determination of a matching security code may be performed either locally by access device 110 or remotely. Data transmitted between access device 110 and a remote device may be performed securely using well-known encryption techniques.

The system and method for establishing a security code and authorizing a security code may be performed using any of a plurality of techniques related to steganography. Rather than using pixel color values, letter size, spacing, typeface, or other characteristics of text or images may be manipulated to carry the security code. Also, sound files may be used to hide a security code.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A method for establishing a security code, comprising:
creating at least one data store;
dividing the data store into a plurality of data items;
receiving a user selection of at least one of the data items;
associating the data items with at least one container file containing a plurality of data values;
specifying locations of a plurality of data values in the container file to form the security code; and
establishing the security code from the plurality of data values in the specified locations.

2. The method of claim 1, wherein the data store comprises an image and the data items comprise sub-images.

3. The method of claim 2, wherein:
the sub-images comprise a plurality of pixels; and
the data values comprise color values associated with the pixels.

4. The method of claim 3, further comprising randomly altering at least one of the color values for at least one of the pixels in the sub-images.

5. The method of claim 4, wherein:
the color values comprise red, green, and blue color values; and
randomly altering at least one of the color values comprises:
detecting noise on a network; and
altering at least one of and red, green, or blue color value for at least one of the pixels based on the detected noise.

6. The method of claim 1, wherein associating the data items with at least one container files comprises:
creating an array with links to the at least one container file;
assigning at least one index to the data items;
storing the index values assigned to the selected data items;
accessing the array at a location using the stored index values; and
retrieving the links to the at least one container file at the accessed location.

7. The method of claim 1, wherein accessing the at least one container file associated with the selected data items to obtain the at least one data value comprises:
executing a mathematical function using the at least one container file to determine at least one offset in the at least one container file containing data values; and
reading the data values at the determined at least one offset.

8. A method for controlling access to a resource, comprising:
associating at least one container file comprising at least one data value with a plurality of data items;
presenting the data items to a user;
receiving a user selection of at least one of the data items;
accessing at least one container file associated with the at least one selected data item;
assembling the at least one data value from the at least one accessed container file into a security code; and
using the security code to control access to the resource.

9. The method of claim 8, wherein presenting the data items to a user comprises presenting a display to the user and wherein the data items comprise sub-images.

10. The method of claim 9, wherein presenting the display to a user comprises presenting the display to a user at a random location on a screen.

11. The method of claim 9, wherein:
the display comprises pixels;
the at least one container file comprises an image file; and
the data values comprise color values of the pixels.

12. The method of claim 8, wherein associating the at least one container file with at least one data item comprises:
embedding information into at least one of the data items; and
using the embedded information to locate at least one container file containing the at least one data value.

13. The method of claim 12, wherein embedding information comprises:
embedding a link comprising an address of the at least one file.

14. The method of claim 8, wherein accessing the at least one container file comprises:
creating an array storing container file names;
associating at least one index with the data items;
storing the index associated with the selected data items;
using the stored index values to access a location in the array; and
obtaining the container file names from the location in the array.

15. The method of claim 14, wherein assembling the at least one data value comprises:
executing a hash function using container file names;
determining the locations of the at least one data value within the at least one container file based on the result of the hash function; and
accessing the at least one data value within the at least one container file at the determined locations.

16. A method for establishing a security code, comprising:
presenting to a user a plurality of data items;
receiving a user selection of at least one of the data items;
associating the selected at least one data item with at least one container file containing a plurality of data values;
specifying locations of a plurality of data values in the container file to form the security code; and
establishing the security code from the plurality of data values in the specified locations.

17. A system for use in establishing a security code, comprising:
a memory for a plurality of data items and at least one container file containing a plurality of data values;
an output for presenting the data items to a user;
an input interface for receiving a user selection of at least one of the data items; and
a processor for associating the selected at least one data item with at least one of the container files, specifying locations of a plurality of data values in the associated at least one container file to form the security code, and establishing the security code from the plurality of data values in the specified locations.

18. A system for use in controlling access to a resource, comprising:
a memory for storing a plurality of data items and at least one container file comprising a plurality of data values;
an output for presenting the data items to a user;
an input interface for receiving a user selection of at least one of the data items; and
a processor for associating at least one of the container files with the selected at least one data item, accessing the at least one container file associated with the selected at least one data item, and assembling the plurality of data values from the accessed container file into a security code, wherein the security code is used to control access to the resource.

19. A computer readable medium comprising program code instructions which, when executed in a processor, perform a method for establishing a security code, comprising:
creating at least one data store;
dividing the data store into a plurality of data items;
receiving a user selection of at least one of the data items;
associating the data items with at least one container file containing a plurality of data values;
specifying locations of a plurality of data values in the container file to form the security code; and
establishing the security code from the plurality of data values in the specified locations.

20. A computer readable medium comprising program code instructions which, when executed in a processor, perform a method for controlling access to a resource, comprising:
associating at least one container file comprising at least one data value with a plurality of data items;
presenting the data items to a user;
receiving a user selection of at least one of the data items;
accessing at least one container file associated with the at least one selected data item;
assembling the at least one data value from the at least one accessed container file into a security code; and
using the security code to control access to the resource.
